(19) United States
(12) Patent Application Publication
(10) Pub. No.: US 2023/0017333 A1
(43) Pub. Date: Jan. 19, 2023

(54) EVENT DETECTION DEVICE

(71) Applicant: NEC Corporation, Minato-ku, Tokyo (JP)

(72) Inventor: Jun PIAO, Tokyo (JP)

(73) Assignee: NEC Corporation, Minato-ku, Tokyo (JP)

(21) Appl. No.: 17/782,922

(22) PCT Filed: Dec. 20, 2019
(86) PCT No.: PCT/JP2019/050114

§ 371 Date: Jun. 6, 2022

(51) Int. Cl. G06T 7/70; G06T 7/38; G06V 10/25; G06V 40/10

(52) U.S. Cl. CPC G06T 7/70; G06T 7/38; G06V 10/25; G06V 40/103; G06V 2201/07

(57) ABSTRACT

A device includes an image acquisition means for acquiring images obtained by capturing an imaging area at different time, a person detection means for detecting a person from each image, an object detection means for detecting an object other than a person from each image, a possession determination means for determining presence of a possession relationship between a person and an object detected from the same image, a same person determination means for determining whether a person detected from one image and a person detected from another image are the same person, a same object determination means for determining whether an object detected from one image and an object detected from another image are the same object, and an event determination means for determining whether a change has occurred in the possession relationship between the person and the object based on the respective determination results, and outputting a determination result.

### TECHNICAL FIELD

The present invention relates to an event detection device, an event detection method, and a storage medium.

### BACKGROUND ART

Recently, technologies of detecting general objects (person and the like) have been studied actively. Along with it, various types of technologies of detecting events such as left-behind, carrying-away, switching, shoplifting, and the like have been proposed.

For example, Patent Literature 1 proposes an image monitoring device that determines a change in presence or absence of possession of an object by a person from an image in which the person is captured, and on the basis of the determination, detects hand-over of a possessed object between persons.

Further, Patent Literature 2 proposes a crime prevention support system that determines whether or not a person possesses an object from an image in which the person is captured, and displays a video in which the person who possesses an object is visible.
Patent Literature 1: JP 6185517 B
Patent Literature 2: JP 4677737 B

### SUMMARY

However, in Patent Literature 1, when there is a difference area, having a size equal to or larger than a reference value, between a first person image and a second person image of the same person extracted from two images captured at different time, it is determined that a change has occurred in presence or absence of the object possessed by the person. In Patent Literature 2, a change in the area of a person is detected, whereby it is determined whether or not the person takes any object by hand. Therefore, in Patent Literatures 1 and 2, while it is possible to detect a change in presence or absence of a possession relationship between a person and an object, that is, a change from an object possession state to an object non-possession state of a person, and a change from an object non-possession state to an object possession state of a person, it is impossible to detect a change in the possession relationship between a person and an object, that is, a fact that an object possessed by a person is changed from one object to another object.

An object of the present invention is to provide an event detection device capable of solving the problem described above, that is, a problem that it is difficult to detect a change in the possession relationship between a person and an object.

An event detection device according to one aspect of the present invention is configured to include

an image acquisition means for acquiring a plurality of images obtained by capturing an imaging area, each of the images being captured at different time,

a person detection means for detecting a person from each of the images,

an object detection means for detecting an object other than a person from each of the images,

a possession determination means for determining presence or absence of a possession relationship between a person and an object detected from the same image,

a same person determination means for determining whether or not a person detected from one image and a person detected from another image, among the plurality of the images, are the same person,

a same object determination means for determining whether or not an object detected from one image and an object detected from another image, among the plurality of the images, are the same object, and

an event determination means for determining whether or not a change has occurred in the possession relationship between the person and the object, on the basis of respective determination results of the possession determination means, the same person determination means, and the same object determination means, and outputting a determination result.

An event detection method according to another aspect of the present invention is configured to include

acquiring a plurality of images obtained by capturing an imaging area, each of the images being captured at different time,

detecting a person from each of the images,

detecting an object other than a person from each of the images,

determining presence or absence of a possession relationship between a person and an object detected from the same image,

determining whether or not a person detected from one image and a person detected from another image, among the plurality of the images, are the same person,

determining whether or not an object detected from one image and an object detected from another image, among the plurality of the images, are the same object, and

determining whether or not a change has occurred in the possession relationship between the person and the object on the basis of respective determination results, and outputting a determination results.

A computer-readable medium according to another aspect of the present invention is configured to store thereon a program for causing a computer to perform processing to

acquire a plurality of images obtained by capturing an imaging area, each of the images being captured at different time,

detect a person from each of the images,

detect an object other than a person from each of the images,

determine presence or absence of a possession relationship between a person and an object detected from the same image,

determine whether or not a person detected from one image and a person detected from another image, among the plurality of the images, are the same person,

determine whether or not an object detected from one image and an object detected from another image, among the plurality of the images, are the same object, and

determine whether or not a change has occurred in the possession relationship between the person and the object on the basis of respective determination results, and output a determination result.

With the configurations described above, the present invention can detect whether or not a change has occurred in the possession relationship between a person and an object.

### BRIEF DESCRIPTION OF DRAWINGS

FIG. 1 is a block diagram of an event detection device according to a first exemplary embodiment of the present invention.

FIG. 2 illustrates an exemplary format of person detection information in the first exemplary embodiment of the present invention.

FIG. 3 illustrates an exemplary format of object detection information in the first exemplary embodiment of the present invention.

FIG. 4 illustrates an exemplary format of possession determination information in the first exemplary embodiment of the present invention.

FIG. 5 illustrates an exemplary format of same person determination information in the first exemplary embodiment of the present invention.

FIG. 6 illustrates an exemplary format of same person determination information in the first exemplary embodiment of the present invention.

FIG. 7 illustrates an exemplary format of tracking information in the first exemplary embodiment of the present invention.

FIG. 8 is a flowchart of an exemplary operation of the event detection device according to the first exemplary embodiment of the present invention.

FIG. 9 is a flowchart illustrating details of processing executed by an event determination unit in the first exemplary embodiment of the present invention.

FIG. 10 is a block diagram of an event detection device according to a second exemplary embodiment of the present invention.

FIG. 11 illustrates an exemplary format of person attribute information in the second exemplary embodiment of the present invention.

FIG. 12 is a flowchart illustrating details of processing executed by an event determination unit in the second exemplary embodiment of the present invention.

FIG. 13 is a block diagram of an event detection device according to the second exemplary embodiment of the present invention.

### EXEMPLARY EMBODIMENTS

Next, exemplary embodiments of the present invention will be described with reference to the drawings.

### First Exemplary Embodiment

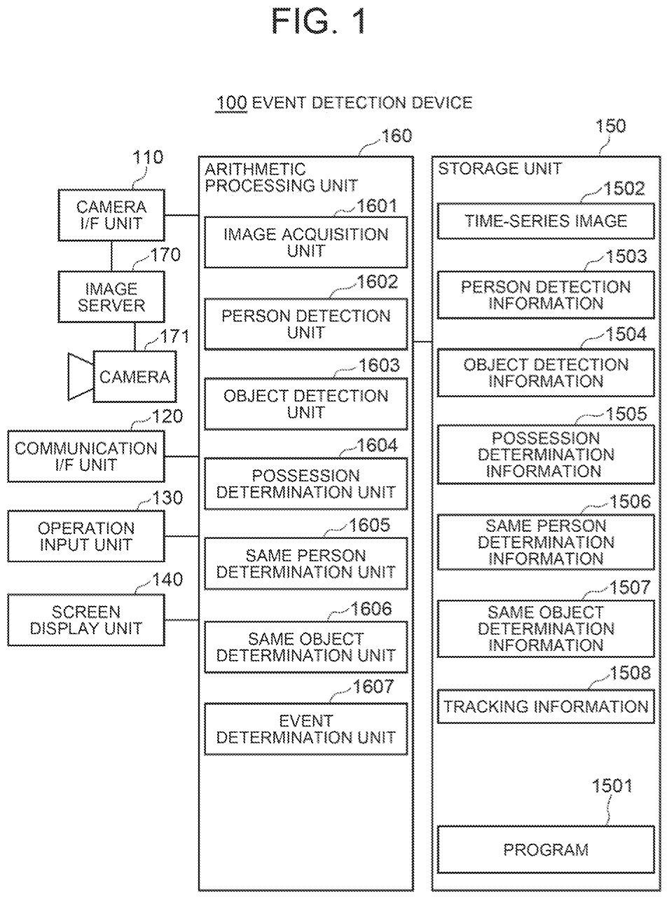

FIG. 1 is a block diagram of an event detection device according to a first exemplary embodiment of the present invention. Referring to FIG. 1, the event detection device 100 is configured to include a camera interface (I/F) unit 110, a communication I/F unit 120, an operation input unit 130, a screen display unit 140, a storage unit 150, and an arithmetic processing unit 160.

The camera I/F unit 110 is connected to an image server 170 in a wired or wireless manner, and is configured to perform data transmission and reception between the image server 170 and the arithmetic processing unit 160. The image server 170 is connected to a camera 171 in a wired or wireless manner, and is configured to accumulate video data, configured of a plurality of time-series images captured by the camera 171, for a past certain period of time. The camera 171 may be a color camera equipped with a charge-coupled device (CCD) image sensor or a complementary MOS (CMOS) image sensor having a pixel capacity of about several millions pixels. The camera 171 may be a camera installed on a street where a plurality of persons and goods come and go, in a room, or the like for the purpose of crime prevention and monitoring. The camera 171 may be a camera that captures the same or different imaging areas from a fixed place in a fixed imaging direction. Alternatively, the camera 171 may be a camera that is mounted on a moving object such as a car and captures the same or different imaging areas while moving.

The communication I/F unit 120 is configured of a data communication circuit, and is configured to perform data communication with an external device, not illustrated, in a wired or wireless manner. The operation input unit 130 is configured of operation input devices such as a keyboard and a mouse, and is configured to detect operation by an operator and output it to the arithmetic processing unit 160. The screen display unit 140 is configured of a screen display device such as a liquid crystal display (LCD), and is configured to display, on a screen, various types of information according to an instruction from the arithmetic processing unit 160.

The storage unit 150 is configured of storage devices such as a hard disk and a memory, and is configured to store therein processing information and a program 1501 necessary for various types of processing in the arithmetic processing unit 160. The program 1501 is a program for implementing various processing units by being read and executed by the arithmetic processing unit 160, and is read in advance from an external device or a storage medium via a data input-output function such as the communication I/F unit 120 and is stored in the storage unit 150. Main processing information stored in the storage unit 150 includes a time-series image 1502, person detection information 1503, object detection information 1504, possession determination information 1505, same person determination information 1506, same object determination information 1507, and tracking information 1508.

The time-series image 1502 is a time-series image captured by the camera 171. The time-series image 1502 may be a frame image constituting a video captured by the camera 171. Alternatively, the time-series image 1502 may be a frame image obtained by down-sampling the frame rate of a video captured by the camera 171. To the time-series image 1502, the imaging time is added. The imaging time of the time-series image 1502 differs for each time-series image.

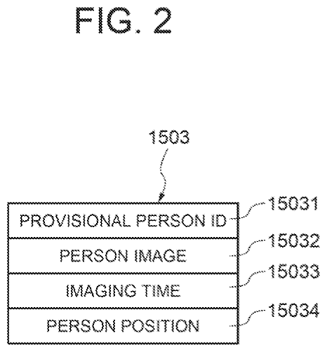

The person detection information 1503 is information according to a person detected from the time-series image 1502. FIG. 2 illustrates an exemplary format of person detection information. The person detection information 1503 of this example is configured of items of a provisional person ID 15031, a person image 15032, imaging time 15033, and a person position 15034. The provisional person ID 15031 is an identification number assigned to a person detected from the time-series image 1502. The provisional person ID 15031 is an ID for uniquely identifying one or more persons detected from the same time-series image 1502. The person image 15032 is an image of a person detected from the time-series image 1502. For example, the person image 15032 is an image inside a bounding rectangle of an image of a person. The imaging time 15033 is the imaging time of the time-series image 1502 from which the person is detected. The person position 15034 is the position of the person image 15032 on the time-series image 1502. The person position 15034 may be, for example, the center of gravity of the person image 15032. However, it is not limited thereto, and may be four vertexes of the bounding rectangle of the person image.

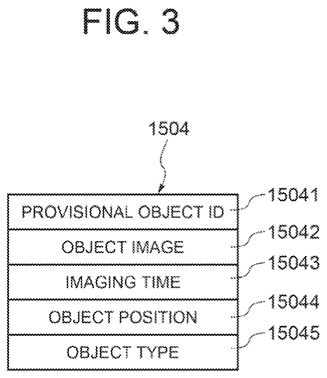

The object detection information 1504 is information according to an object detected from the time-series image 1502. FIG. 3 illustrates an exemplary format of object detection information. The object detection information 1504 of this example is configured of items of a provisional object ID 15041, an object image 15042, imaging time 15043, an object position 15044, and an object type 15045. The provisional object ID 15041 is an identification number assigned to an object detected from the time-series image 1502. The provisional object ID 15041 is an ID for uniquely identifying one or more objects detected from the same time-series image 1502. The object image 15042 is an image of an object detected from the time-series image 1502. For example, the object image 15042 is an image inside a bounding rectangle of an image of an object. The imaging time 15043 is the imaging time of the time-series image 1502 from which the object is detected. The object position 15044 is a position of the object image 15042 on the time-series image 1502. The object position 15044 may be, for example, the center of gravity of the object image 15042. However, it is not limited thereto, and may be four vertexes of the bounding rectangle of the object image. The object type 15045 is the type (class) of an object such as a bag, a backpack, a book, or an umbrella.

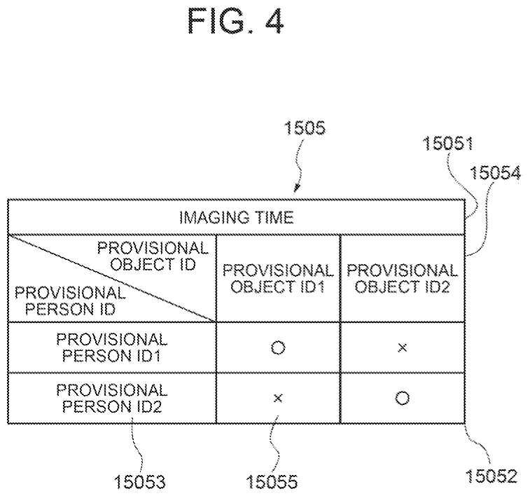

The possession determination information 1505 is information representing a determination result of presence or absence of a possession relationship between a person and an object detected from the time-series image 1502. FIG. 4 illustrates an exemplary format of the possession determination information 1505. The possession determination information 1505 of this example is configured of imaging time 15051 and a matrix 15052. The imaging time 15051 is the imaging time of the time-series image 1502. The matrix 15052 is configured such that the provisional person IDs 15053 are shown in the vertical direction (column direction) and the provisional object IDs 15054 are shown in the horizontal direction (line direction), and information of presence or absence of a possession relationship is recorded at an intersection point 15055 between a line and a column. The number of lines of the matrix 15052 is equal to the number of persons detected from the time-series image 1502. The number of columns of the matrix 15052 is equal to the number of objects detected from the time-series image 1502. For example, in the matrix 15052 illustrated in FIG. 4, a circle mark is shown at the intersection point between a provisional person ID 1 and a provisional object ID 1. This indicates that a person identified by the provisional person ID 1 and an object identified by the provisional object ID 1 has a possession relationship, that is, the person specified by the provisional person ID 1 possesses the object specified by the provisional object ID 1. Further, in the matrix 15052 illustrated in FIG. 4, an x-mark is shown at the intersection point between the provisional person ID 1 and a provisional object ID 2. This indicates that a person identified by the provisional person ID 1 and an object identified by the provisional object ID 2 does not have a possession relationship, that is, the person identified by the provisional person ID 1 does not possess the object identified by the provisional object ID 2.

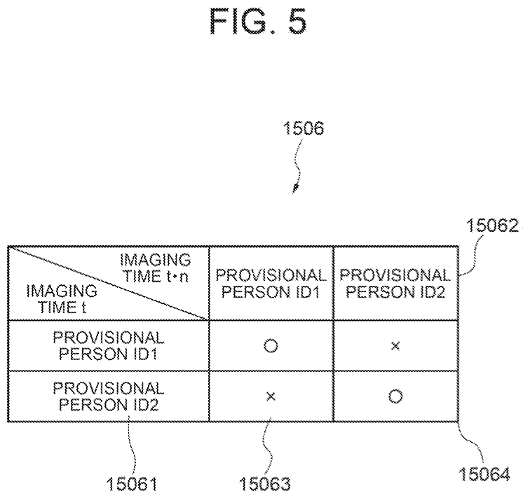

The same person determination information 1506 is information representing a result of determining whether or not a person image detected from one time-series image, of the two time-series images 1502 whose imaging times are different, and a person image detected from the other time-series image are person images of the same person. FIG. 5 illustrates an exemplary format of the same person determination information 1506. The same person determination information 1506 of this example is configured of a matrix 15064. The matrix 15064 is configured such that a provisional person ID 15061 identifying a person image detected from a time-series image 1502 captured at imaging time t on the future side, of the two time-series images having different imaging time, is shown on the vertical direction (column direction), and a provisional person ID 15062 identifying a person image detected from a time-series image 1502 captured at imaging time t-n on the past side is shown on the horizontal direction (line direction), and information indicating whether or not they are the same person is recorded on the intersection point 15063 between the line and the column. The number of lines of the matrix 15064 is equal to the number of persons detected from the time-series images 1502 on the future side. The number of columns of the matrix 15064 is equal to the number of persons detected from the time-series images 1502 on the past side. For example, in the matrix 15064 illustrated in FIG. 5, a circle mark is shown at the intersection point between a provisional person ID 1 captured at the imaging time t and a provisional person ID 1 captured at the imaging time t-n. This indicates that the person image identified by the provisional person ID 1, captured at the imaging time t, and the person image identified by the provisional person ID 1, captured at the imaging time t-n, are images of the same person. Further, in the matrix 15064 illustrated in FIG. 5, an x-mark is shown at the intersection point between the provisional person ID 1 captured at the imaging time is t and a provisional person ID 2 captured at the imaging time t-n. This indicates that the person image identified by the provisional person ID 1, captured at the imaging time t, and the person image identified by the provisional person ID 2, captured at the imaging time t-n, are not images of the same person.

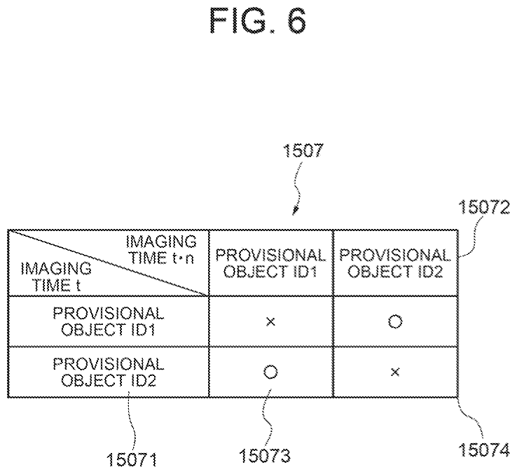

The same object determination information 1507 is information representing a result of determining whether or not an object image detected from one time-series image, of the two time-series images 1502 whose imaging time is different, and an object image detected from the other time-series image are object images of the same object. FIG. 6 illustrates an exemplary format of the same object determination information 1507. The same object determination information 1507 of this example is configured of a matrix 15074. The matrix 15074 is configured such that a provisional object ID 15071 identifying an object image detected from a time-series image 1502 captured at the imaging time t on the future side, of the two time-series images having different imaging time, is shown in the vertical direction (column direction), and a provisional object ID 15072 identifying an object image detected from a time-series image 1502 captured at the imaging time t-n on the past time is shown in the horizontal direction (line direction), and information indicating whether or not they are the same object is recorded at the intersection point 15073 between the line and the column. The number of lines of the matrix 15074 is equal to the number of objects detected from the time-series images 1502 on the future side. The number of columns of the matrix 15074 is equal to the number of objects detected from the time-series images 1502 on the past side. For example, in the matrix 15074 illustrated in FIG. 6, an x-mark is shown at the intersection point between a provisional object ID 1 captured at the imaging time is t and the provisional object ID 1 captured at the imaging time is t-n. This indicates that the object image identified by the provisional object ID 1, captured at the imaging time t, and the object image identified by the provisional object ID 1, captured at the imaging time t-n, are not images of the same object. Meanwhile, in the matrix 15074 illustrated in FIG. 6, a circle mark is shown at the intersection point between the provisional object ID 1 captured at the imaging time t and a provisional object ID 2 captured at the imaging time t-n. This indicates that the object image identified by the provisional object ID 1, captured at the imaging time t, and the object image identified by the provisional object ID 2, captured at the imaging time t-n, are images of the same object.

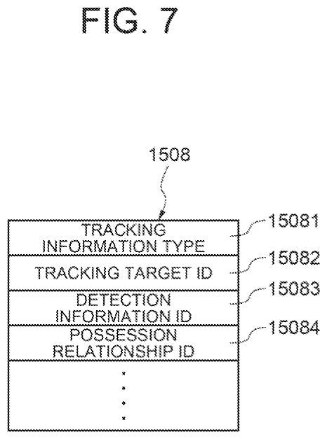

The tracking information 1508 is information in which pieces of person detection information of the same person or pieces of object detection information of the same object are associated with each other for each imaging time and linked with a management number or the like. FIG. 7 illustrates an exemplary format of the tracking information 1508. The tracking information 1508 of this example is configured of items of a tracking information type 15081, a tracking target ID 15082, a detection information ID 15083, and a possession relationship ID 15084. The tracking information type 15081 is information representing whether the tracking information 1508 is person tracking information in which person detection information of the same person is associated, or object tracking information in which object detection information of the same object is associated. The object target ID 15082 is a person ID or an object ID assigned to a person or an object to be tracked. The tracking target ID 15082 is an ID that is unique although the imaging time is different, which is different from the provisional person ID and the provisional object ID as described above.

Regarding a set of the detection information ID 15083 and the possession relationship ID 15084, the number thereof is the same as the number of pieces of person detection information of the same person or the number of pieces of object detection information of the same object. The detection information ID 15083 of one set is information identifying one piece of person detection information of one piece of object detection information of the same person or the same object. For example, the detection information ID 15083 may be a combination of the provisional person ID 15031 and the imaging time 15033 of the person detection information 1503, or a combination of the provisional object ID 15041 and the imaging time 15043 of the object detection information 1504. The possession relationship ID 15084 is information representing whether or not object detection information or person detection information having a possession relationship with the person detection information or the object detection information identified by the detection information ID 15083 of the same set is detected, and if it is detected, representing an ID identifying the object detection information or the person detection information having a possession relationship (for example, a combination of the provisional object ID 15041 and the imaging time 15043 of the object detection information 1504, or a combination of the provisional person ID 15031 and the imaging time 15033 of the person detection information 1503).

The arithmetic processing unit 160 has a processor such as an MPU and the peripheral circuits, and is configured to read and execute the program 1501 from the storage unit 150 to allow the hardware and the program 1501 to cooperate with each other to thereby implement the various processing units. Main processing units implemented by the arithmetic processing unit 160 include an image acquisition unit 1601, a person detection unit 1602, an object detection unit 1603, a possession determination unit 1604, a same person determination unit 1605, a same object determination unit 1606, and an event determination unit 1607.

The image acquisition unit 1601 is configured to acquire, from the image server 170 via the camera I-F unit 110, a plurality of time-series images captured by the camera 171 or time-series images obtained by down-sampling them, and store them in the storage unit 150 as the time-series images 1502.

The person detection unit 1602 is configured to read out the latest time-series image 1502 from the storage unit 150, and detect a person image from the time-series image 1502. The person detection unit 1602 is configured to, for example, with an input of the time-series image 1502 into a learning model having been learned through machine learning for estimating a person image from a camera image, acquire a person image existing in the time-series image 1502 from the learning model. The learning model can be generated in advance through machine learning using a machine learning algorism such as a neural network by using various camera images and various person images in the camera images as teacher data. However, the method of detecting a person image from the time-series image 1502 is not limited to that described above. Another method such as pattern matching may be used. Further, the person detection unit 1602 is configured to store, in the storage unit 150, a provisional person ID, the imaging time, and the person position collectively as the person detection information 1503, for each detected person image.

The object detection unit 1603 is configured to read out the latest time-series image 1502 from the storage unit 150, and detect an object image from the time-series image 1502. The object detection unit 1603 is configured to, for example, with an input of the time-series image 1502 into a learning model having been learned through machine learning for estimating an object image and an object type from a camera image, acquire an object image existing in the time-series image 1502 and the object type thereof from the learning model. The learning model can be generated in advance through machine learning using a machine learning algorism such as a neural network by using various camera images and various object images in the camera images as teacher data. However, the method of detecting an object image and the object type thereof from the time-series image 1502 is not limited to that described above. Another method such as pattern matching may be used. Further, the object detection unit 1603 is configured to store, in the storage unit 150, a provisional object ID, the imaging time, and the object position collectively as the object detection information 1504, for each set of the object image and the object type detected.

The possession determination unit 1604 is configured to read out the person detection information 1503 and the object detection information 1504 detected from the latest time-series image 1502 from the storage unit 150, determine presence or absence of a possession relationship between a person of the person image and an object of the object image detected from the time-series image 1502 at that time, and store the determination result in the storage unit 150 as the possession determination information 1505. For example, the possession determination unit 1604 focuses on one piece of person detection information 1503 detected from the latest time-series image 1502, and determines that among the pieces of object determination information 1504 detected from the latest time-series image 1502, the object detection information 1504 having the object position 15044 whose distance in the image from the person position 15034 in the focused person detection information 1503 is a predetermined distance or shorter has a possession relationship with the person in the focused person detection information. Further, the possession determination unit 1604 determines that the object detection information 1504 whose distance exceeds the predetermined distance has no possession relationship with the person in the focused the person detection information. The possession determination unit 1604 performs the same processing on the remaining person detection information 1503. Then, the possession determination unit 1604 expresses the determination result in the form of the matrix 15052 illustrated in FIG. 4, generates the possession determination information 1505 by adding the imaging time 15051 of the time-series image 1502 thereto, and stores it in the storage unit 150.

The same person determination unit 1605 is configured to read out, from the storage unit 150, the person detection information 1503 detected from the latest time-series image 1502 (hereinafter referred to as latest person detection information) and the person detection information 1503 detected from at least one past time-series image 1502 (hereinafter referred to as past person detection information) having a predetermined temporal relation with the latest time-series image 1502, and determine whether or not a person image of the latest person detection information 1503 and a person image of the past person detection information 1503 are person images of the same person. The at least one past time-series image having a predetermined temporal relation with the latest time-series image 1502 may be a time-series image 1502 that is immediately before the latest time-series image 1502. Alternatively, the at least one past time-series image having a predetermined temporal relation with the latest time-series image 1502 may be a time-series image 1502 that is immediately before the latest time-series image 1502 and a time-series image 1502 that is two images before the latest time-series image 1502. Here, while the number of past time-series images is one or two, the number of past time-series images may be three or more if they have a predetermined temporal relation with the latest time-series image 1502.

The same person determination unit 1605 is configured to, for example, with an input of a person image of the latest person detection information 1503 and a person image of the past person detection information 1503 into the learning model having been learned by machine learning for estimating whether or not the two person images are person images of the same person, acquire an estimation result of whether or not they are person images of the same person from the learning model. The learning model can be generated in advance through machine learning using a machine learning algorism such as a neural network by using various pairs of person images of the same person and various pairs of person images of different persons as teacher data. However, the method of determining whether or not two person images are person images of the same person is not limited to that described above. Another method such as a method of determining whether or not the distance between feature vectors extracted from two person images is a predetermined distance or shorter may be used.

Further, the same person determination unit 1605 is configured to express a determination result of whether or not a person image of the latest person detection information 1503 and a person image of the past person detection information 1503 are person images of the same image in the form of the matrix 15064 as illustrated in FIG. 5, and store it in the storage unit 150.

The same object determination unit 1606 is configured to read out, from the storage unit 150, the object detection information 1504 detected from the latest time-series image 1502 (hereinafter referred to as latest object detection information) and the object detection information 1504 detected from at least one past time-series image 1502 (hereinafter referred to as past object detection information) having a predetermined temporal relation with the latest time-series image 1502, and determine whether or not the object image of the latest object detection information 1504 and the object image of the past object detection information 1504 are object images of the same object. The same object determination unit 1606 is configured to, for example, with an input of an object image of the latest object detection information 1504 and an object image of the past object detection information 1504 into the learning model having been learned by machine learning for estimating whether or not the two object images are object images of the same object, acquire an estimation result of whether or not they are object images of the same object from the learning model. The learning model can be generated in advance through machine learning using a machine learning algorism such as a neural network by using various pairs of object images of the same object and various pairs of object images of different objects as teacher data. However, the method of determining whether or not two object images are object images of the same object is not limited to that described above. Another method such as a method of determining whether or not the distance between feature vectors extracted from two object images is a predetermined distance or shorter may be used. Further, it is also possible to compare object types 15045 between the object image of the latest object detection information 1504 and the object image of the past object detection information 1504, and when the object types 15045 are not the same, it is determined that the two images are not object images of the same object. Meanwhile, when the object types 15045 are the same, whether or not they are the same may be determined by performing same object determination with use of the learning model or performing same object determination with use of the feature vector. Further, the same object determination unit 1606 is configured to express a determination result of whether or not the object image of the latest object detection information 1504 and the object image of the past object detection information 1504 are object images of the same object in the form of the matrix 15074 as illustrated in FIG. 6, and store it in the storage unit 150.

The event determination unit 1607 is configured to, each time the processing on the latest time-series image 1502 by the person detection unit 1602, the object detection unit 1603, the possession determination unit 1604, the same person determination unit 1605, and the same object determination unit 1606 is completed, read out the latest possession determination information 1505, the same person determination information 1506, and the same object determination information 1507 from the storage unit 150, and on the basis of the information, generate and update the tracking information 1508 corresponding to the same person and the same object as appropriate. The event determination unit 1607 is also configured to analyze the generated or updated tracking information 1508 to thereby detect a change in the possession relationship between the person and the object. The event determination unit 1607 is also configured to output (transmit) text, voice, images and the like showing the information related to the detected event to an external device via the communication I/F unit 120, and/or output them to (display on) the screen display unit 140. For example, the event determination unit 1607 may output an image in which the bounding rectangle of the person image and the bounding rectangle of the object image in which a change in the possession relationship is detected are combined on the time-series image at the point of time when a change in the possession relationship between the person and the object is detected.

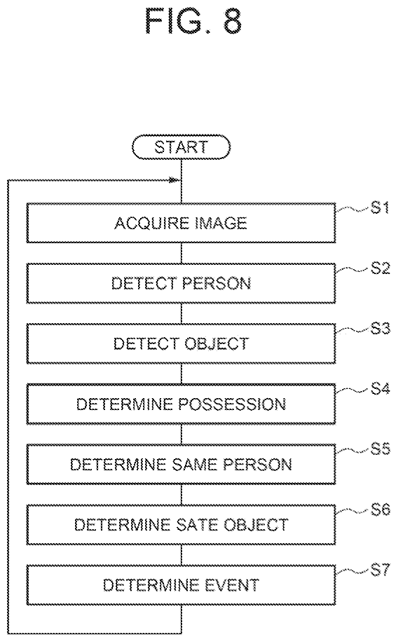

FIG. 8 is a flowchart illustrating an exemplary operation of the event detection device 100 according to the present embodiment. Referring to FIG. 8, first, the image acquisition unit 1601 acquires, from the image server 170 via the camera I/F unit 110, a plurality of time-series images captured by the camera 171 or time-series images obtained by down-sampling them, and stores them in the storage unit 150 as the time-series images 1502 (step S1). Then, the person detection unit 1602 reads out the latest time-series image 1502 from the storage unit 150, detects a person image from the time-series image 1502, and for each person image detected, calculates a provisional person ID, the imaging time, and the person position, and stores them collectively as the person detection information 1503 in the storage unit 150 (step S2). Then, the object detection unit 1603 reads out the latest time-series image 1502 from the storage unit 150, detects an object image and the object type represented by the object image from the time-series image 1502, and for each set of the object image and the object type detected, calculates a provisional object ID, the imaging time, and the object position, and stores them collectively as the object detection information 1504 in the storage unit 150 (step S3). Then, the possession determination unit 1604 reads out the person detection information 1503 and the object detection information 1504 detected from the latest time-series image 1502 from the storage unit 150, determines presence or absence of a possession relationship between a person of the person image and an object of the object image detected from the time-series image 1502, and stores the determination result in the storage unit 150 as the possession determination information 1505 (step S4). Then, the same person determination unit 1605 reads out, from the storage unit 150, the person detection information 1503 detected from the latest time-series image 1502 (latest person detection information) and the person detection information 1503 detected from at least one past time-series image 1502 (past person detection information) having a predetermined temporal relation with the latest time-series image 1502, and determines whether or not the person image of the latest person detection information 1503 and the person image of the past person detection information 1503 are person images of the same person, and stores the same person determination information 1506 in the storage unit 150 (step S5). Then, the same object determination unit 1606 reads out, from the storage unit 150, the object detection information 1504 detected from the latest time-series image 1502 (latest object detection information) and the object detection information 1504 detected from at least one past time-series image 1502 (past object detection information) having a predetermined temporal relation with the latest time-series image 1502, determines whether or not the object image of the latest object detection information 1504 and the object image of the past object detection information 1504 are object images of the same object, and stores the same object determination information 1507 in the storage unit 150 (step S6). Then, the event determination unit 1607 reads out the latest possession determination information 1505, the same person determination information 1506, and the same object determination information 1507 from the storage unit 150, and on the basis of those pieces of information, determines whether or not any change occurs in the possession relationship between the person and the object, transmits the determination result to an external device via the communication I/F unit 120 and/or displays it on the screen display unit 140 (step S7). Then, the event detection device 100 returns to step S1, and repeats the operation similar to the operation described above.

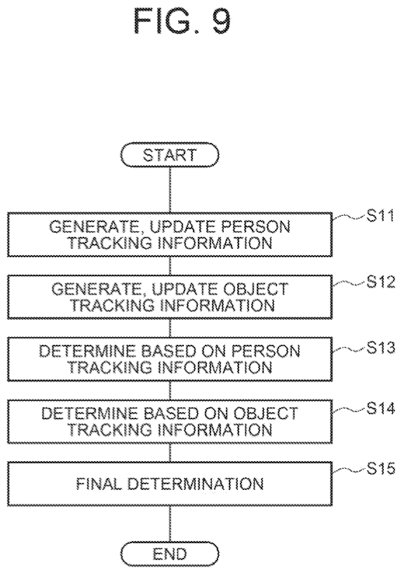

FIG. 9 is a flowchart illustrating the details of step S7 executed by the event determination unit 1607. Referring to FIG. 9, first, for each same person, the event determination unit 1607 generates and/or updates the tracking information 1508 of the same person on the basis of the latest possession determination information 1505, the same person determination information 1506, and the same object determination information 1507 (step S11).

At step S11, for a person determined, by the same person determination unit 1605, not to be the same person as any persons detected from the past time-series images among the persons detected from the latest time-series images 1502, that is, for a person detected in the latest time-series image 1502 for the first time, the event determination unit 1607 newly generates tracking information 1508 of the person. At that time, the event determination unit 1607 sets the type representing the person to the tracking information type 15081 illustrated in FIG. 7, sets a person ID assigned to the person to the tracking object ID, sets the imaging time and a provisional person ID of the person detection information 1503 of the person detected from the latest time-series image 1502 to the detection information ID 15083, and sets, to the possession relationship ID 15084, a NULL value when it is determined by the possession determination unit 1604 that the person does not possess an object, while sets information identifying the possessed object (for example, the imaging time and the provisional object ID for identifying the object detection information 1504) when it is determined that the person possesses an object, respectively.

Further, at step S11, for a person determined, by the same person determination unit 1605, to be the same person as any person detected from the past time-series images among the persons detected from the latest time-series images 1502, the event determination unit 1607 adds a pair of the latest detection information ID 15083 and the possession relationship ID 15084 to the tracking information 1508 having been created for the person. That is, the event determination unit 1607 adds the detection information ID 15083 in which the imaging time of the person detection information 1503 and the provisional person ID of the person detection information 1503 of the person detected from the latest time-series image 1502 are set, and the possession relationship ID 15084 in which a NULL value is set when the person does not possess an object in the latest time-series image 1502, while information specifying the possessed object is set when the person possesses an object.

Then, for each same object, the event determination unit 1607 generates and/or updates the tracking information 1508 of the same object on the basis of the latest possession determination information 1505, the same person determination information 1506, and the same object determination information 1507 (step S12).

At step S12, for an object determined, by the same object determination unit 1606, not to be the same object as any objects detected from the past time-series images among the objects detected from the latest time-series images 1502, the event determination unit 1607 newly generates the tracking information 1508 of the object. At that time, the event determination unit 1607 sets the type representing the object to the tracking information type 15081 illustrated in FIG. 7, sets an object ID assigned to the object to the tracking object ID, sets the imaging time and a provisional object ID of the object detection information 1504 of the object detected from the latest time-series image 1502 to the detection information ID 15083, and sets, to the possession relationship ID 15084, a NULL value when it is determined by the possession determination unit 1604 that the object is not possessed by any person, while sets information identifying the possessor (for example, the imaging time and a provisional person ID for identifying the person detection information 1503) when it is determined that the object is possessed.

Further, at step S12, for an object determined, by the same object determination unit 1606, to be the same object as any object detected from the past time-series images among the objects detected from the latest time-series images 1502, that is, for an object whose tracking information 1508 already exists, the event determination unit 1607 adds a pair of the latest detection information ID 15083 and the possession relationship ID 15084 to the tracking information 1508 of the object. That is, the event determination unit 1607 adds the detection information ID 15083 in which the imaging time and the provisional person ID of the object detection information 1504 of the object detected from the latest time-series image 1502 are set, and the possession relationship ID 15084 in which a NULL value is set when the object is not possessed by any person in the latest time-series image 1502, while information specifying the person who possesses it (for example, imaging time and the provisional person ID of the person detection information 1503) is set when the object is possessed.

Then, for each tracking information 1508 of the same person updated at step S11, the event determination unit 1607 determines whether or not any change occurs in the possession relationship between the person and the object (step S13). Specifically, the event determination unit 1607 determines whether or not the state of the person is changed from an object possession state to an object non-possession state, or on the contrary, whether or not the state is changed from an object non-possession state to an object possession state, or whether or not the object is changed from one object to another object. For example, when determining that the state of the person is changed from an object possessing state to an object non-possession state, the event determination unit 1607 generates determination information configured of a change type representing that the state is changed from a possession state to a non-possession state, the person ID of the person, the changed time, and the object ID of the object held before the change. Meanwhile, when determining that the state of the person is changed from an object non-possession state to an object possession state, the event determination unit 1607 generates determination information configured of a change type representing that the state is changed from a non-possession state to a possession state, the person ID of the person, the changed time, and the object ID of the object possessed after the change. Meanwhile, when determining that the object possessed by the person is changed from one object to another object, the event determination unit 1607 generates determination information configured of a change type representing that object is changed, the person ID of the person, the changed time, and the object ID of the object possessed before the change, and the object ID of the object possessed after the change.

Then, for each tracking information 1508 of the same object updated at step S12, the event determination unit 1607 determines whether or not any change occurs in the possession relationship between the object and the person (step S14). Specifically, the event determination unit 1607 determines whether or not the state of object is changed from a possessed state with a possessor to a non-possessed state without a possessor, or on the contrary, whether or not the state of the object is changed from a non-possessed state without a possessor to a possessed state with a possessor, or whether or not the possessor is changed from one person to another person. For example, when determining that the state of the object is changed from a possessed state with a possessor to a non-possessed state without a possessor, the event determination unit 1607 generates determination information configured of a change type representing that the state is changed from a possessed state to a non-possessed state, the object ID of the object, the changed time, and the person ID of the person who is the possessor before the change. Meanwhile, when determining that the state of the object is changed from a non-possessed state without a possessor to a possessed state with a possessor, the event determination unit 1607 generates determination information configured of a change type representing that the state is changed from a non-possessed state to a possessed state, the object ID of the object, the changed time, and the person ID of the person who is the possessor after the change. Further, when determining that the possessor of the object is changed from one person to another person, the event determination unit 1607 generates determination information configured of a change type representing that the possessor is changed, the object ID of the object, the changed time, the person ID of the person who is the possessor before the change, and the person ID of the person who is the possessor after the change.

Then, the event determination unit 1607 comprehensively determines the determination result based on the tracking information of the same person performed at step S13 and the determination result based on the tracking information of the same object performed at step S14, and finally determines whether or not a change occurs in the possession relationship between the person and the object (step S15).

For example, the event determination unit 1607 may use a result obtained by simply collecting the determination result based on the tracking information of the same person performed at step S13 and the determination result based on the tracking information of the same object performed at step S14, as a final determination result. As a result, as compared with the case of performing determination based on either one of the tracking information of the same person and the tracking information of the same object, it is possible to detect whether or not a change occurs in the possession relationship between the person and the object without omission. This is because there is a case where a change in the possession relationship between a person and an object that cannot be detected by the tracking information of the same person can be detected by the tracking information of the same object, and vice versa.

The event determination unit 1607 may compare the determination result based on the tracking information of the same person performed at step S13 and the determination result based on the tracking information on the same object performed at step S14 with each other, and put together the changes in the possession relationship between the person and the object that are logically the same into one. For example, the event determination unit 1607 may put together a determination result based on the tracking information of the same person in which the state of a person A is changed from a state of possessing an object X to a state of not possessing it at time t1, and a determination result based on the tracking information of the same object in which a state where the object is possessed by a possessor A to a state where the object is not possessed by anyone at time t1, and generate a determination result that the possession relationship between the person A and the object is changed from a possession state to a non-possession state at time t1. As a result, redundant determination results can be reduced.

Further, the event determination unit 1607 may compare a determination result based on the tracking information of a person performed at step S13 and a determination result based on the tracking information of another person with each other, and put together the changes in the possession relationships between a plurality of persons and objects. For example, the event determination unit 1607 may put together a determination result that the state of the person A is changed from a state of possessing the object X to a state of not possessing it at time t1, and a determination result that the state of a person B who is in the vicinity thereof at time t1 is changed from a non-possession state to a state of possessing the object X, and generate a determination result that the object X is given from the person A to a person B at the time around time t1. Alternatively, the event determination unit 1607 may put together a determination result that the state of the person A is changed from a state of possessing the object X to a state of possessing an object Y, and a determination result that the state of the person B is changed from a state of possessing the object Y to a state of possessing the object X at the time around time t1, and generate a determination result that the object X possessed by the person A and the object X possessed by the person B are exchanged between the person A and the person B at the time around time t1.

Further, the event determination unit 1607 may compare a determination result based on the tracking information of an object performed at step S14 and a determination result based on the tracking information of another object with each other, and put together the changes in the possession relationships between a plurality of persons and objects. For example, the event determination unit 1607 may put together a determination result that the state of the object X is changed from a state of being possessed by the person A to a state of not being possessed at time t1, and a determination result that the state of the object X is changed from a state of not being possessed to a state of being possessed by the person B at the time around time t1, and generate a determination result that the object X is given from the person A to the person B at the time around time t1. Alternatively, the event determination unit 1607 may put together a determination result that the state of the object X is changed from a state of being possessed by the person A to a state of being possessed by the person B at time t1, and a determination result that the state of the object Y is changed from a state of being possessed by the person B to a state of being possessed by the person A at the time around time t1, and generate a determination result that the object X possessed by the person A and the object X possessed by the person B are exchanged between the person A and the person B at the time around time t1.

As described above, according to the event detection device 100 of the present embodiment, it is possible to detect a change in presence or absence of a possession relationship between a person and an object, and also detect a change in the possession relationship between a person and an object, that is, a fact that an object possessed by one person is changed from one object to another object. This is because the event detection device 100 includes the image acquisition unit 1601 that acquires a plurality of time-series images 1502 obtained by capturing an imaging area at different time, the person detection unit 1602 that detects a person from each time-series image 1502, the object detection unit 1603 that detects an object other than a person from each time-series image 1502, the possession determination unit 1604 that determines presence or absence of a possession relationship between a person and an object detected from the same time-series image 1502, the same person determination unit 1605 that determines whether or not a person detected from one time-series image and a person detected from another time-series image, among a plurality of time-series images, are the same person, the same object determination unit 1606 that determines whether or not an object detected from one time-series image and an object detected from another time-series image, among a plurality of time-series images 1502, are the same object, and the event determination unit 1607 that determines whether or not a change has occurred in the possession relationship between a person and an object on the basis of determination results of the possession determination unit 1604, the same person determination unit 1605, and the same object determination unit 1606.

### Second Exemplary Embodiment

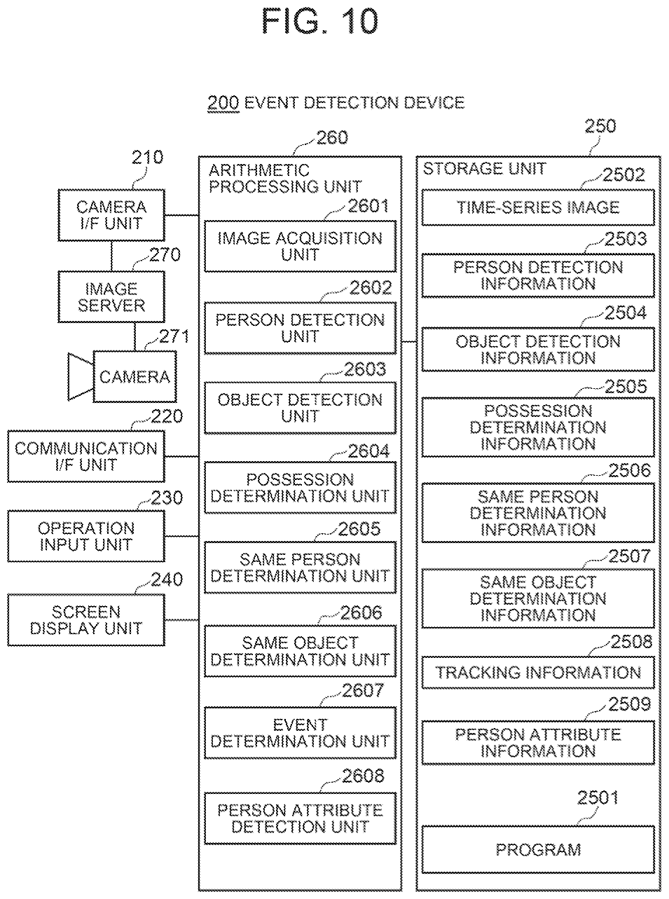

FIG. 10 is a block diagram of an event detection device 200 according to a second exemplary embodiment of the present invention. Referring to FIG. 10, the event detection device 200 according to the present embodiment is configured to includes a camera interface (I/F) unit 210, a communication I/F unit 220, an operation input unit 230, a screen display unit 240, a storage unit 250, and an arithmetic processing unit 260. Among them, the camera I/F unit 210, the communication I/F unit 220, the operation input unit 230, and the screen display unit 240 have the same configurations as those of the camera I/F unit 110, the communication I/F unit 120, the operation input unit 130, and the screen display unit 140 of the event detection device 100 according to the first exemplary embodiment.

The storage unit 250 is configured of storage devices such as a hard disk and a memory, and is configured to store therein processing information and a program 2501 necessary for various types of processing in the arithmetic processing unit 260. The program 2501 is a program for implementing various processing units by being read and executed by the arithmetic processing unit 260, and is read in advance from an external device or a storage medium via a data input-output function such as the communication I/F unit 220 and is stored in the storage unit 250. Main processing information stored in the storage unit 250 includes a time-series image 2502, person detection information 2503, object detection information 2504, possession determination information 2505, same person determination information 2506, same object determination information 2507, tracking information 2508, and person attribute information 2509. Among them, the time-series image 2502, the person detection information 2503, the object detection information 2504, the possession determination information 2505, the same person determination information 2506, the same object determination information 2507, and the tracking information 2508 are the same as the time-series image 1502, the person detection information 1503, the object detection information 1504, the possession determination information 1505, the same person determination information 1506, the same object determination information 1507, and the tracking information 1508 in the event detection device 100 according to the first exemplary embodiment.

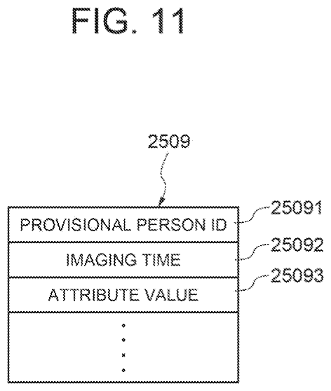

The person attribute information 2509 is information of an attribute value of a person detected from the time-series image 1502. The attribute values of a person are values of one or more predetermined attributes such as gender, age group, hairstyle, wearing or not wearing glasses, and a style of clothes. FIG. 11 illustrates an exemplary format of the person attribute information 2509. The person attribute information 2509 of this example is configured of items of a provisional person ID 25091, imaging time 25092, and one or more attribute values 25093. The provisional person ID 25091 and the imaging time 25092 are information uniquely identifying a person image detected from the time-series image 1502, and are the same as the provisional person ID 15031 and the imaging time 15033 in the person detection information 2503 illustrated in FIG. 2. The one or more attribute values 25093 are values representing the gender, age group, hairstyle, wearing or not wearing glasses, a style of clothes, and the like described above.

The arithmetic processing unit 260 has a processor such as an MPU and the peripheral circuits, and is configured to read and execute the program 2501 from the storage unit 250 to allow the hardware and the program 2501 to cooperate with each other to thereby implement the various processing units. Main processing units implemented by the arithmetic processing unit 260 include an image acquisition unit 2601, a person detection unit 2602, an object detection unit 2603, a possession determination unit 2604, a same person determination unit 2605, a same object determination unit 2606, an event determination unit 2607, and a person attribute detection unit 2608. Among them, the image acquisition unit 2601, the person detection unit 2602, the object detection unit 2603, the possession determination unit 2604, the same person determination unit 2605, the same object determination unit 2606, and the event determination unit 2607 are configured similarly to the image acquisition unit 1601, the person detection unit 1602, the object detection unit 1603, the possession determination unit 1604, the same person determination unit 1605, the same object determination unit 1606, and the event determination unit 1607 of the event determination unit 100 illustrated in FIG. 1.

The person attribute detection unit 2608 is configured to detect an attribute value of a person from the person image 15032 detected from the time-series image 2502 by the person detection unit 2602. The person attribute detection unit 2608 is configured to, for example, with an input of the person image 15032 into a learning model having been learned through machine learning for estimating an attribute value of a person from a person image, acquire an attribute value of the person from the learning model. The learning model can be generated in advance through machine learning using a machine learning algorism such as a neural network by using various person images and various attribute values as teacher data. However, the method of detecting an attribute value of a person from the person image 15032 is not limited to that described above. Another method such as pattern matching may be used. Further, the person attribute detection unit 2608 is configured to collectively store, in the storage unit 250, a detected attribute value of the person, and the provisional person ID and the imaging time set in the person image 15032 from which detection is made, as the person attribute information 2509.

Next, operation of the event detection device 200 according to the present embodiment will be described. The operation of the event detection device 200 is the same as the operation of the event detection device 100 according to the first exemplary embodiment except that an operation of the person attribute detection unit 2608 is added.

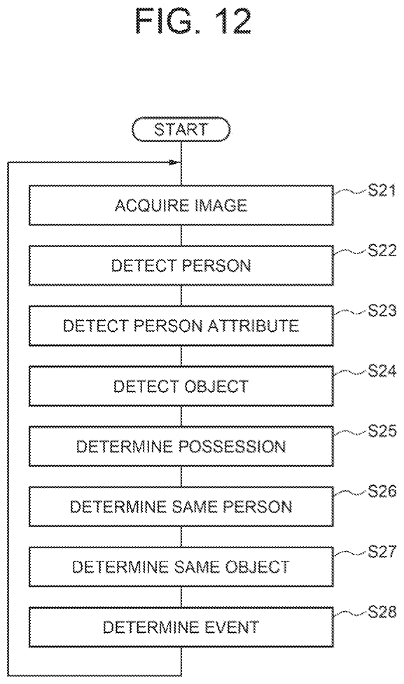

FIG. 12 is a flowchart illustrating an exemplary operation of the event detection device 200 according to the present invention, in which steps S21, S22, and S24 to S28 are the same as steps S1 to S7 of FIG. 8. Referring to FIG. 12, following the operations of steps S21 and S22 by the image acquisition unit 2601 and the person detection unit 2602, the person attribute detection unit 2608 detects an attribute value of the person from the person image 15032 detected by the person detection unit 2602, and puts together the detected attribute value and the provisional person ID of the person and the imaging time as the person attribute information 2509, and stores it in the storage unit 250 (step S23). Then, as similar to the first exemplary embodiment, operations of steps S24 to 28 are performed by the possession determination unit 2604, the same person determination unit 2605, the same object determination unit 2606, and the event determination unit 2607.

Further, in the present embodiment, when the event determination unit 2607 outputs video data configured of time-series images before and after the detection of a change in the possession relationship between the person and the object, the event determination unit 2607 acquires, from the person attribute information 2509, an attribute value of the person in which a change in the possession relationship has been detected, and synthesizes the text of the attribute value near the person image of the person for example and displays it. As a result, it is possible to allow the surveillant to know the feature of a person who behaves suspiciously. Note that an attribute value of a person in which a change in the possession relationship has been detected may be output as sound, besides text display.

As described above, according to the event detection device 200 of the present embodiment, it is possible to achieve an advantageous effect similar to that of the first exemplary embodiment, and to notify the surveillant or the like of an attribute value of a person in which a change in the possession relationship has been detected.

In the above description, the person attribute detection unit 2608 is provided independent of the person detection unit 2602 and the same person determination unit 2605. However, the person attribute detection unit 2608 may be incorporated in the person detection unit 2602 and the same person determination unit 2605. That is, the person detection unit 2602 may be configured to detect an image of a person from the time-series image 2502 and also detect an attribute value of the detected person. Further, the same person determination unit 2605 may be configured to, when determining whether or not a person image detected from a time-series image and a person image detected from another time-series image are person images of the same person, detect attribute values of the persons of the two person images.

### Third Exemplary Embodiment

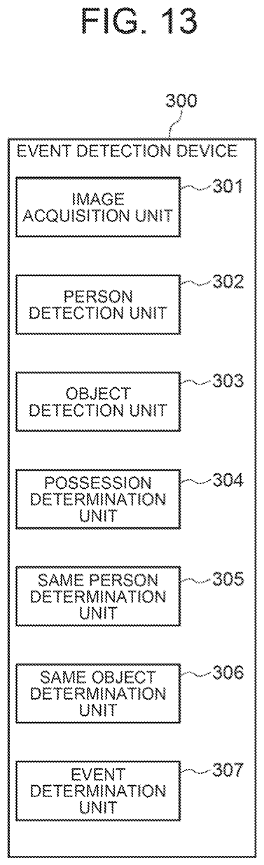

Next, a third exemplary embodiment of the present invention will be described with reference to FIG. 13. FIG. 13 is a block diagram of an event detection device according to the present embodiment. The present embodiment describes the outlines of the event detection devices described above.

Referring to FIG. 13, an event determination unit 300 of the present embodiment includes an image acquisition unit 301, a person detection unit 302, an object detection unit 303, a possession determination unit 304, a same person determination unit 305, a same object determination unit 306, and an event determination unit 307.

The image acquisition unit 301 is configured to acquire a plurality of images obtained by capturing an imaging area at different time. The image acquisition unit 301 may have the same configuration as that of the image acquisition unit 1601 of FIG. 1, but it is not limited thereto.

The person detection unit 302 is configured to detect a person from each image acquired by the image acquisition unit 301. The person detection unit 302 may have the same configuration as that of the person detection unit 1602 of FIG. 1 for example, but is not limited thereto.

The object detection unit 303 is configured to detect an object other than a person from each image acquired by the image acquisition unit 301. The object detection unit 303 may have the same configuration as that of the object detection unit 1603 of FIG. 1 for example, but is not limited thereto.

The possession determination unit 304 is configured to determine presence or absence of a possession relationship between a person and an object detected from the same image. The possession determination unit 304 may have the same configuration as that of the possession determination unit 1604 of FIG. 1 for example, but is not limited thereto.

The same person determination unit 305 is configured to determine whether or not a person detected from one image and a person detected from another image, among a plurality of images, are the same person. The same person determination unit 305 may have the same configuration as that of the same person determination unit 1605 of FIG. 1 for example, but is not limited thereto.

The same object determination unit 306 is configured to determine whether or not an object detected from one image and an object detected from another image, among a plurality of images, are the same object. The same object determination unit 306 may have the same configuration as that of the same object determination unit 1606 of FIG. 1 for example, but is not limited thereto.

The event determination unit 307 is configured to determine whether or not a change has occurred in the possession relationship between a person and an object on the basis of determination results of the possession determination unit 304, the same person determination unit 305, and the same object determination unit 306, and output the determination result. The event determination unit 307 may have the same configuration as that of the event determination unit 1607 of FIG. 1 for example, but is not limited thereto.

The event detection device 300 according to the present embodiment configured as described above operates as described below. First, the image acquisition unit 301 acquires a plurality of images obtained by capturing an imaging area at different time. Then, the person detection unit 302 detects a person from each image acquired by the image acquisition unit 301, and the object detection unit 303 detects an object other than a person from each image acquired by the image acquisition unit 301. Then, the possession determination unit 304 determines presence or absence of a possession relationship between a person and an object detected from the same image, the same person determination unit 305 determines whether or not a person detected from one image and a person detected from another image, among a plurality of images, are the same person, and the same object determination unit 306 determines whether or not an object detected from one image and an object detected from another image, among a plurality of images, are the same object. Then, the event determination unit 307 determines whether or not a change has occurred in the possession relationship between a person and an object on the basis of determination results of the possession determination unit 304, the same person determination unit 305, and the same object determination unit 306, and outputs the determination result.

According to the event detection device 300 that is configured and operates as described above, it is possible to detect a change in presence or absence of a possession relationship between a person and an object, and also detect a change in the possession relationship between a person and an object, that is, a fact that an object possessed by one person is changed to another object. This is because the event detection device 300 includes the image acquisition unit 301 that acquires a plurality of images obtained by capturing an imaging area at different time, the person detection unit 302 that detects a person from each image, the object detection unit 303 that detects an object other than a person from each image, the possession determination unit 304 that determines presence or absence of a possession relationship between a person and an object detected from the same image, the same person determination unit 305 that determines whether or not a person detected from one image and a person detected from another image, among a plurality of images, are the same person, the same object determination unit 306 that determines whether or not an object detected from one image and an object detected from another image, among a plurality of images, are the same object, and the event determination unit 307 that determines whether or not a change has occurred in the possession relationship between a person and an object on the basis of determination results of the possession determination unit, the same person determination unit, and the same object determination unit, and outputs the determination result.

While the present invention has been described with reference to the exemplary embodiments described above, the present invention is not limited to the above-described embodiments. The form and details of the present invention can be changed within the scope of the present invention in various manners that can be understood by those skilled in the art. For example, an image acquisition unit may be configured to acquire time-series images from a plurality of cameras capturing the same imaging area or different imaging areas.

### INDUSTRIAL APPLICABILITY

The present invention can be applicable to the technology of detecting events such as left-behind of an object by a person, carrying-away, switching, shoplifting, and the like.

The whole or part of the exemplary embodiments disclosed above can be described as, but not limited to, the following supplementary notes.

### (Supplementary Note 1)

An event detection device comprising:

image acquisition means for acquiring a plurality of images obtained by capturing an imaging area, each of the images being captured at different time;

person detection means for detecting a person from each of the images;

object detection means for detecting an object other than a person from each of the images;

possession determination means for determining presence or absence of a possession relationship between a person and an object detected from a same image;

same person determination means for determining whether or not a person detected from one image and a person detected from another image, among the plurality of the images, are a same person;

same object determination means for determining whether or not an object detected from one image and an object detected from another image, among the plurality of the images, are a same object; and

event determination means for determining whether or not a change has occurred in the possession relationship between the person and the object, on a basis of respective determination results of the possession determination means, the same person determination means, and the same object determination means, and outputting a determination result.

### (Supplementary Note 2)

The event detection device according to supplementary note 1, wherein

the event determination means is configured to generate, for each same person, person tracking information associated with information indicating whether or not the person possesses an object, and when the person possesses an object, associated with object detection information of the possessed object for each imaging time, and perform the determination on a basis of the person tracking information.

### (Supplementary Note 3)

The event detection device according to supplementary note 1 or 2, wherein

the event determination means is configured to generate, for each same object, object tracking information associated with information indicating whether or not there is a possessor, and when there is a possessor, associated with person detection information of the possessor for each imaging time, and perform the determination on a basis of the object tracking information.

### (Supplementary Note 4)

The event detection device according to any of supplementary notes 1 to 3, wherein the event determination means is configured to output, as the determination result, an image formed by combining a bounding rectangle of a person image and a bounding rectangle of an object image in which a change in the possession relationship is detected, on a time-series image at a point of time when the change in the possession relationship between the person and the object is detected.

### (Supplementary Note 5)

The event detection device according to supplementary note 4, further comprising

person attribute detection means for detecting attribute information of the person from the person image, wherein

the event determination means is configured to output the detected attribute information along with the determination result.

### (Supplementary Note 6)

An event detection method comprising:

acquiring a plurality of images obtained by capturing an imaging area, each of the images being captured at different time;

detecting a person from each of the images;

detecting an object other than a person from each of the images;

determining presence or absence of a possession relationship between a person and an object detected from a same image;

determining whether or not a person detected from one image and a person detected from another image, among the plurality of the images, are a same person;

determining whether or not an object detected from one image and an object detected from another image, among the plurality of the images, are a same object; and

determining whether or not a change has occurred in the possession relationship between the person and the object on a basis of respective determination results, and outputting a determination result.

### (Supplementary Note 7)

The event detection method according to supplementary note 6, wherein

the determining whether or not a change has occurred include generating, for each same person, person tracking information associated with information indicating whether or not the person possesses an object, and when the person possesses an object, associated with object detection information of the possessed object for each imaging time, and performing the determination on a basis of the person tracking information.

### (Supplementary Note 8)

The event detection method according to supplementary note 6 or 7, wherein

the determining whether or not a change has occurred includes generating, for each same object, object tracking information associated with information indicating whether or not there is a possessor, and when there is a possessor, associated with person detection information of the possessor for each imaging time, and performing the determination on a basis of the object tracking information.

### (Supplementary Note 9)

The event detection method according to any of supplementary notes 6 to 8, wherein the outputting the determination result includes outputting, as the determination result, an image formed by combining a bounding rectangle of a person image and a bounding rectangle of an object image in which a change in the possession relationship is detected, on a time-series image at a point of time when the change in the possession relationship between the person and the object is detected.

### (Supplementary Note 10)

The event detection method according to supplementary note 9, further comprising

detecting attribute information of the person from the person image, wherein

the outputting the determination result includes outputting the detected attribute information along with the determination result.

### (Supplementary Note 11)

A computer-readable medium storing thereon a program for causing a computer to perform processing to:

acquire a plurality of images obtained by capturing an imaging area, each of the images being captured at different time;

detect a person from each of the images;

detect an object other than a person from each of the images;

determine presence or absence of a possession relationship between a person and an object detected from a same image;

determine whether or not a person detected from one image and a person detected from another image, among the plurality of the images, are a same person;

determine whether or not an object detected from one image and an object detected from another image, among the plurality of the images, are a same object; and

determine whether or not a change has occurred in the possession relationship between the person and the object on a basis of respective determination results, and output a determination result.

### REFERENCE SIGNS LIST

100 event detection device
110 camera I/F unit
120 communication I/F unit
130 operation input unit
140 screen display unit
150 storage unit
160 arithmetic processing unit

What is claimed is:

1. An event detection device comprising:
a memory containing program instructions; and
a processor coupled to the memory, wherein the processor is configured to execute the program instructions to:
acquire a plurality of images obtained by capturing an imaging area, each of the images being captured at different time;
detect a person from each of the images;
detect an object other than a person from each of the images;
determine presence or absence of a possession relationship between a person and an object detected from a same image;
determine whether or not a person detected from one image and a person detected from another image, among the plurality of the images, are a same person;
determine whether or not an object detected from one image and an object detected from another image, among the plurality of the images, are a same object; and
determine whether or not a change has occurred in the possession relationship between the person and the object, on a basis of a result of determining presence or absence of the possession relationship, a result of determining whether or not the person is the same person, and a result of determining whether or not the object is the same object, and outputting a determination result.

2. The event detection device according to claim 1, wherein
the determining whether or not a change has occurred in the possession relationship includes generating, for each same person, person tracking information associated with information indicating whether or not the person possesses an object, and when the person possesses an object, associated with object detection information of the possessed object for each imaging time, and performing the determination on a basis of the person tracking information.

3. The event detection device according to claim 1, wherein
the determining whether or not a change has occurred in the possession relationship includes generating, for each same object, object tracking information associated with information indicating whether or not there is a possessor, and when there is a possessor, associated with person detection information of the possessor for each imaging time, and performing the determination on a basis of the object tracking information.

4. The event detection device according to claim 1, wherein
the outputting the determination result includes outputting, as the determination result, an image formed by combining a bounding rectangle of a person image and a bounding rectangle of an object image in which a change in the possession relationship is detected, on a time-series image at a point of time when the change in the possession relationship between the person and the object is detected.

5. The event detection device according to claim 4, wherein the processor is further configured to execute the instructions to
detect attribute information of the person from the person image, wherein
the outputting the determination result includes outputting the detected attribute information along with the determination result.

6. An event detection method comprising:
acquiring a plurality of images obtained by capturing an imaging area, each of the images being captured at different time;
detecting a person from each of the images;
detecting an object other than a person from each of the images;
determining presence or absence of a possession relationship between a person and an object detected from a same image;
determining whether or not a person detected from one image and a person detected from another image, among the plurality of the images, are a same person;
determining whether or not an object detected from one image and an object detected from another image, among the plurality of the images, are a same object; and
determining whether or not a change has occurred in the possession relationship between the person and the object on a basis of respective determination results, and outputting a determination result.

7. The event detection method according to claim 6, wherein
the determining whether or not a change has occurred include generating, for each same person, person tracking information associated with information indicating whether or not the person possesses an object, and when the person possesses an object, associated with object detection information of the possessed object for each imaging time, and performing the determination on a basis of the person tracking information.

8. The event detection method according to claim 6, wherein
the determining whether or not a change has occurred includes generating, for each same object, object tracking information associated with information indicating whether or not there is a possessor, and when there is a possessor, associated with person detection information of the possessor for each imaging time, and performing the determination on a basis of the object tracking information.

9. The event detection method according to claim 6, wherein
the outputting the determination result includes outputting, as the determination result, an image formed by combining a bounding rectangle of a person image and a bounding rectangle of an object image in which a change in the possession relationship is detected, on a time-series image at a point of time when the change in the possession relationship between the person and the object is detected.

10. The event detection method according to claim 9, further comprising
detecting attribute information of the person from the person image, wherein
the outputting the determination result includes outputting the detected attribute information along with the determination result.

11. A non-transitory computer-readable medium storing thereon a program comprising instructions for causing a computer to perform processing to:
acquire a plurality of images obtained by capturing an imaging area, each of the images being captured at different time;
detect a person from each of the images;
detect an object other than a person from each of the images;
determine presence or absence of a possession relationship between a person and an object detected from a same image;
determine whether or not a person detected from one image and a person detected from another image, among the plurality of the images, are a same person;
determine whether or not an object detected from one image and an object detected from another image, among the plurality of the images, are a same object; and
determine whether or not a change has occurred in the possession relationship between the person and the object on a basis of respective determination results, and output a determination result.

12. The event detection device according to claim 1, wherein
the determining presence or absence of the possession relationship includes, for each set of a person and an object detected from the same image, determining that there is a possession relationship between the person and the object when a distance between the person and the object in the image is equal to or less than a predetermined distance, and determining that there is no possession relationship between the person and the object when the distance exceeds the predetermine distance.

13. The event detection method according to claim 6, wherein
the determining presence or absence of the possession relationship includes, for each set of a person and an object detected from the same image, determining that there is a possession relationship between the person and the object when a distance between the person and the object in the image is equal to or less than a predetermined distance, and determining that there is no possession relationship between the person and the object when the distance exceeds the predetermine distance.
